(19) United States
(12) Patent Application Publication
(10) Pub. No.: US 2010/0323725 A1
(43) Pub. Date: Dec. 23, 2010

(54) INDIVIDUALIZED RETRY CONFIGURATIONS FOR MESSAGES HAVING FAILED DELIVERY

(76) Inventors: Yigang Cai, Naperville, IL (US); Suzann Hua, Lisle, IL (US)

Correspondence Address: DUFT BORNSEN & FISHMAN, LLP, 1526 SPRUCE STREET, SUITE 302, BOULDER, CO, 80302, US

(21) Appl. No.: 12/486,892

(22) Filed: Jun. 18, 2009

(51) Int. Cl. H04W 4/12

(52) U.S. Cl. 455/466

(57) ABSTRACT

Systems and methods are disclosed for handling retry attempts for a message based on an individualized retry configuration. One embodiment comprises a message center for a mobile network. The message center includes a retry database that stores retry configurations each defining rules for retry attempts of a message. The message center further includes a delivery system that receives a message (e.g., text/multimedia), initiates a delivery attempt to the destination, and identifies a failure of the delivery attempt. After the failure, the delivery system initiates a retry process by identifying an individualized retry configuration for the message from the retry database. The individualized retry configuration may define a number of subsequent retry attempts and time intervals between the retry attempts. The delivery system then initiates one or more retry attempts of the message to the destination based on the individualized retry configuration.

### BACKGROUND

1. Field of the Invention

The invention is related to the field of communications and, in particular, to delivery of messages that previously had a failed delivery.

2. Statement of the Problem

In many mobile networks, text and multimedia messaging has become a very popular mode of communication. One example of a text messaging service is Short Message Service (SMS), which is a communication protocol allowing the exchange of short text messages (i.e., 160 characters) between mobile devices. One example of a multimedia messaging service is Multimedia Message Service (MMS), which is a communication protocol allowing the exchange of multimedia messages (i.e., digital pictures, media clips, etc) between mobile devices. Often times, mobile users more frequently use text or multimedia messaging for communication than voice calls.

Text messages are transmitted over signaling channels of a mobile network, such as over SS7 channels. An SMS Center (SMSC) in the mobile network has a store-and-forward system for delivering text messages to their destinations. Upon initially receiving a text message, the store-and-forward system first stores (persistently) the text message, and then initiates a delivery attempt for the text message. If the first delivery attempt is unsuccessful, then the store-and-forward system enters a retry process. For the retry process, the network operator predefines a global retry configuration for all text messages. Thus, the store-and-forward system identifies the global retry configuration, and then attempts to deliver the text message to the destination according to the global retry configuration. For example, the global retry configuration may define that a maximum of three retry attempts should be made at an interval of thirty minutes. After the failed delivery of the text message, the store-and-forward system waits for thirty minutes and then initiates a retry attempt for the text message. If the first retry attempt is unsuccessful, then the store-and-forward system again waits for thirty minutes and initiates a second retry attempt. This process of retrying delivery occurs three times before the text message is discarded. A similar process occurs for multimedia messages (e.g., MMS) or other types of messages.

One problem encountered by network operators is that when the mobile network becomes congested, there may be a higher incident of failed deliveries for text or multimedia messages. Thus, the store-and-forward system will continually initiate retry attempts for the failed deliveries according to the global retry configuration. Unfortunately, the global retry configuration can actually worsen the congestion of the mobile network through frequent and multiple retry attempts.

### SUMMARY

Embodiments described herein are able to identify individualized retry configurations for each message (e.g., text/multimedia message) being delivered instead of relying on a global retry configuration for all messages. An individualized retry configuration may be identified or selected based on information regarding delivery of the message, such as a destination identifier (ID), a sender ID, traffic conditions, time/date, etc. Thus, a retry configuration may be selected from a plurality of different retry configurations for each message, which was not possible using a global retry configuration. Some advantages of selecting a retry configuration on a per-message basis are that the cost of message delivery may be controlled, the traffic load on the network due to retry may be controlled, and the likelihood of a successful delivery may increase.

One embodiment comprises a message center for a mobile network. The message center includes a retry database operable to store a plurality of retry configurations each defining rules for retry attempts (i.e., subsequent delivery attempts) of a message. The message center further includes a delivery system operable to receive a message (e.g., text/multimedia message) intended for a destination, and initiate a delivery attempt of the message to the destination. If the delivery attempt is unsuccessful, then the delivery system is further operable to identify a failure of the delivery attempt. After the failure, the delivery system is operable to initiate a retry process. For the retry process, the delivery system is operable to identify an individualized retry configuration for the message from the plurality of retry configurations stored in the retry database. The individualized retry configuration may define a number (e.g., maximum) of subsequent retry attempts for this specific message, and may also define one or more time intervals between the retry attempts for this specific message. The delivery system is further operable to initiate one or more retry attempts of the message to the destination based on the individualized retry configuration.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a mobile network in an exemplary embodiment.

FIG. 2 is a flow chart illustrating a method of retrying delivery of messages using an individualized retry configuration in an exemplary embodiment.

FIG. 3 is a flow chart illustrating a process for initiating retry attempts in an exemplary embodiment.

FIG. 4 illustrates a retry configuration table that maps destination IDs to retry configurations in an exemplary embodiment.

FIG. 5 is a flow chart illustrating a method of identifying a retry configuration from a retry configuration table in an exemplary embodiment.

FIG. 6 illustrates a retry configuration table that maps network condition error codes to retry configurations in an exemplary embodiment.

FIG. 7 is a flow chart illustrating a method of identifying a retry configuration from a retry configuration table in an exemplary embodiment.

FIG. 8 illustrates a retry configuration table that maps times to retry configurations in an exemplary embodiment.

FIG. 9 is a flow chart illustrating a method of identifying a retry configuration from a retry configuration table in an exemplary embodiment.

FIG. 10 illustrates an IMS network in an exemplary embodiment.

FIGS. 11-12 are message diagrams illustrating retry delivery using an individualized retry configuration in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

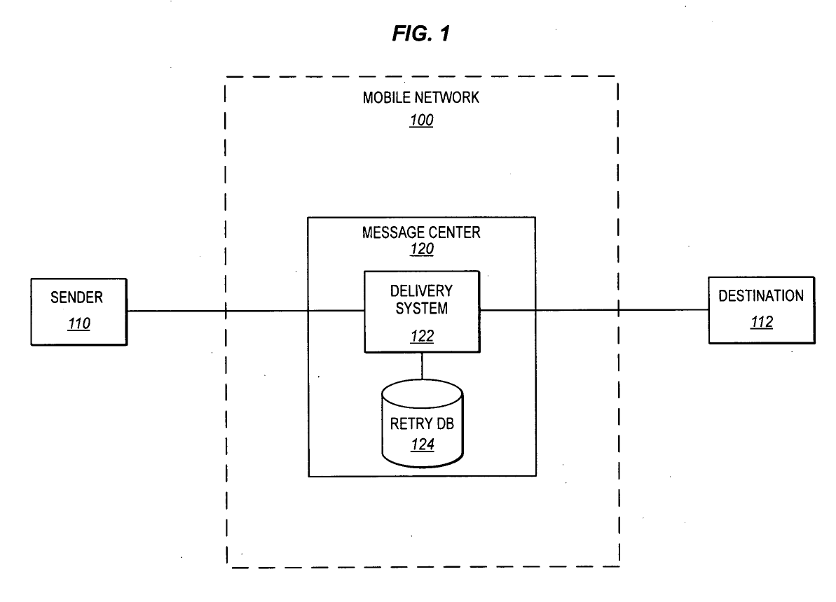

FIG. 1 illustrates a mobile network 100 in an exemplary embodiment. Mobile network 100 may comprise a circuit-based network, such as a CDMA network or a GSM network, may comprise a packet-based network, such as an IP Multimedia Subsystem (IMS) network, or a mix of the two. Mobile network 100 is able to facilitate the transfer of a text message, a multimedia message, or some other type of message from a sender 110 to a destination 112. Because sender 110 and destination 112 may be served by different networks, mobile network 100 may represent an “originating” network for a Mobile Originating (MO) scenario, or may represent a “terminating” network for a Mobile Terminating (MT) scenario.

In this embodiment, mobile network 100 includes a message center 120. Message center 120 comprises any system, server, application, or function operable to handle the delivery of messages. For example, message center 120 may comprise an SMSC that implements SMS protocol to deliver text or SMS messages. In another example, message center 120 may comprise an MMSC that implements MMS protocol to deliver multimedia or MMS messages. In this embodiment, message center 120 includes a delivery system 122 and a retry database 124. Delivery system 122 comprises any device, component, system, or application operable to attempt delivery of messages to destinations. As one example, delivery system 122 may include a store-and-forward system utilizing SMS protocol or another type of store-and-forward protocol. Retry database 124 comprises any storage system operable to store a plurality of retry configurations each defining rules for retry attempts (i.e., subsequent delivery attempts) of an individual message. A retry attempt refers to a delivery attempt performed after an initial delivery attempt has failed. The rules defined in the plurality of retry configurations may be different so that retry is not performed in the same manner for all messages.

In one embodiment, the retry configuration defines the number (maximum) of subsequent retry attempts for a message, and a time interval between each of the retry attempts. For example, one retry configuration may define a maximum of three retry attempts, with 10 minutes between the initial delivery attempt and the first retry attempt, 30 minutes between the first retry attempt and the second retry attempt, and 12 hours between the second retry attempt and the third retry attempt. Another retry configuration may define that there is a maximum of two retry attempts, with 30 minutes between the initial delivery attempt and the first retry attempt, and 30 minutes between the first retry attempt and the second retry attempt.

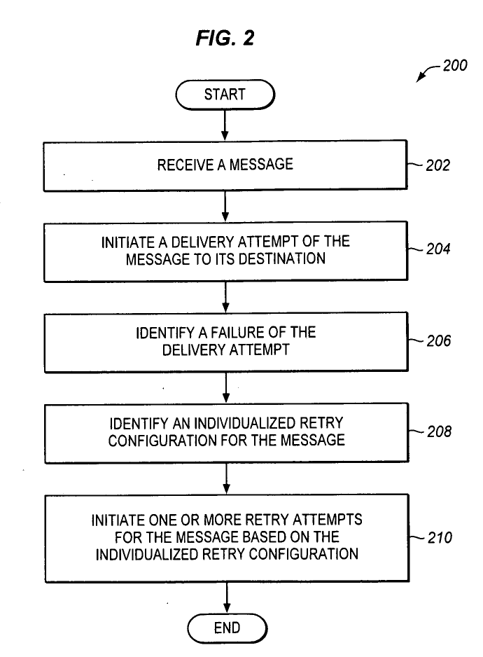

In the embodiments described below, message center 120 is able to apply an individualized retry configuration on a per-message basis. When message center 120 determines that a delivery attempt for a message has failed, message center 120 may process information regarding delivery of the message to identify which retry configuration applies for this message. For example, message center 120 may process a destination identifier (ID), a sender ID, traffic conditions, time/date, etc, to identify which retry configuration applies for this message. Thus, the retry configuration is individualized for each message, instead of being a global configuration for all messages. A more detailed operation of message center 120 is illustrated in FIG. 2.

FIG. 2 is a flow chart illustrating a method 200 of retrying delivery of messages using an individualized retry configuration in an exemplary embodiment. The steps of method 200 will be described with reference to mobile network 100 in FIG. 1, but those skilled in the art will appreciate that method 200 may be performed in other networks and systems. Also, the steps of the flow chart in FIG. 2 are not all inclusive and may include other steps not shown. The steps may be performed in an alternative order.

Assume in FIG. 1 that sender 110 sends a message, such as a text/multimedia message, to mobile network 100 that is intended for destination 112. The term “text/multimedia” means that the message may comprise a text message or a multimedia message. Although text/multimedia messages may be referenced in this embodiment, other types of messages may be used in other embodiments. Delivery system 122 (in message center 120) receives the message in step 202 (see FIG. 2). Those skilled in the art will appreciate that the message may be encapsulated in a signaling message, such as an SS7 message or a SIP message. Delivery system 122 then initiates a delivery attempt of the message to destination 112 in step 204. For example, delivery system 122 may implement store-and-forward processing to initiate a first delivery attempt of the message to destination 112. To do so, delivery system 122 stores (persistently) the message in memory (not shown), and delivery system 122 then attempts to deliver the message to destination 112. If the first delivery attempt is unsuccessful, then delivery system 122 identifies a failure of the first or initial delivery attempt in step 206. After the failure, delivery system 122 initiates a retry process, which is a process that attempts to deliver the message to destination 112 zero or more times before the message is discarded.

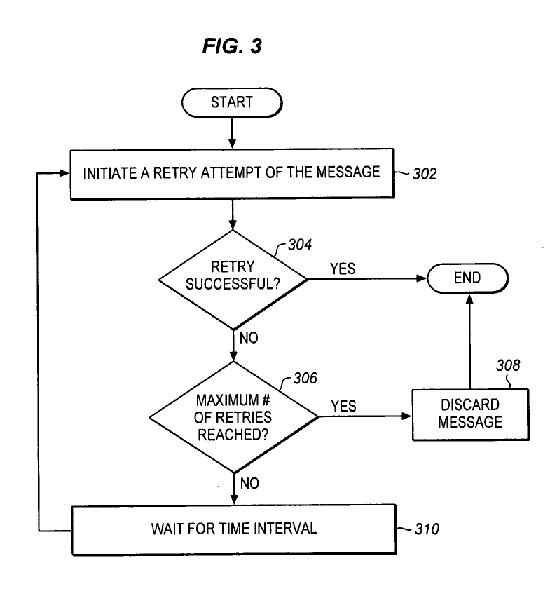

For the retry process, delivery system 122 identifies an individualized retry configuration for the message from the plurality of retry configurations stored in retry database 124 in step 208. The individualized retry configuration may define a number (e.g., maximum) of subsequent retry attempts for this specific message, and may also define one or more time intervals between the retry attempts for this specific message. Delivery system 122 then initiates one or more retry attempts of the message to destination 112 based on the individualized retry configuration in step 210. In one embodiment, a process for initiating retry attempts as in step 210 is illustrated in FIG. 3. In step 302, delivery system 122 initiates a retry attempt of the message based on the individualized retry configuration. In step 304, delivery system 122 determines whether or not the retry attempt was successful. If the retry attempt was successful, then the process ends. If the retry attempt was not successful, then delivery system 122 determines whether the maximum number of retry attempts defined in the individualized retry configuration is reached in step 306. If the maximum number is reached, then delivery system 122 discards the message in step 308. If the maximum number is not reached, then delivery system 122 waits for the time interval defined in the individualized retry configuration, and then returns to step 302 to initiate another retry attempt.

In FIG. 2, method 200 repeats for the next message that is received. It is evident from FIG. 2 that an individualized retry configuration is identified for each message having a failed delivery. There is no global retry configuration that applies to all messages, but an individualized retry configuration is determined dynamically for each message. For example, if a first message is received, then delivery system 122 identifies a first retry configuration for the first message. If a second message is received, then delivery system 122 identifies a second retry configuration the second message. The first and second retry configurations may be different for the first and second messages. Thus, a global retry configuration is not used in these embodiments, as an individualized retry configuration is determined dynamically for each message that is received.

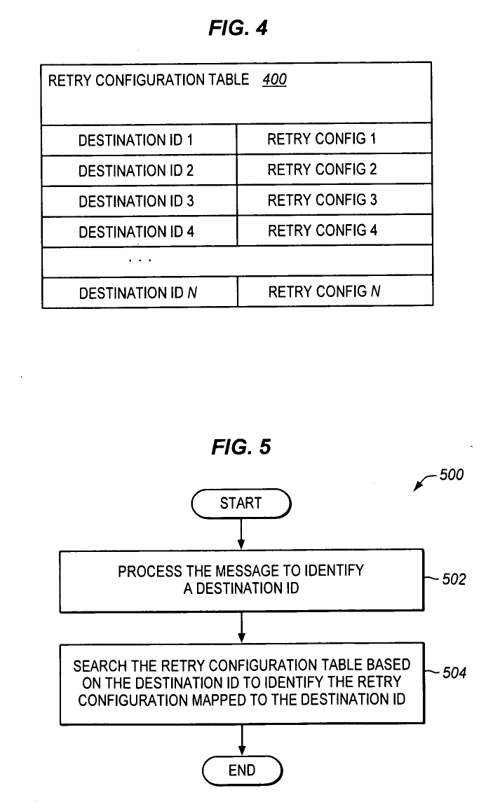

To identify the proper retry configuration from retry database 124 for an individual message, delivery system 122 may process information regarding delivery of the message. For one embodiment, delivery system 122 may process information on the destination 112 of the message, such as a destination identifier (ID). Additionally, retry database 124 may store a retry configuration table that maps or associates destination information to retry configurations. As an example, FIG. 4 illustrates a retry configuration table 400 that maps destination IDs to retry configurations in an exemplary embodiment. In this embodiment, retry configuration table 400 includes a plurality of destinations identifiers labeled as destination ID 1, destination ID 2, destination ID 3, destination ID 4, . . . , destination ID N. The destination ID may be a directory number, a network address, a network point code, an E.164 number, or some other identifier of the destination. The destination IDs may also indicate a range of destination IDs or a destination type (e.g., roaming, foreign network, etc). Each of these destination IDs is mapped to or associated with a retry configuration labeled as retry configuration 1, retry configuration 2, retry configuration 3, retry configuration 4, . . . , retry configuration N. The retry configuration indicates a maximum number of retry attempts, and a time interval between the retry attempts.

As an example, assume that destination ID 1 refers to a single ID or a plurality of IDs for a foreign network. When the destination is in a foreign network, delivery system 122 queries an HLR or HSS in the foreign network to acquire routing information for each retry attempt, which is charged to the network operator. Thus, the network operator may define a retry configuration for foreign destination IDs that is sensitive to cost of multiple queries. For example, retry configuration 1 may define a maximum of one retry attempt, with the interval between the initial delivery attempts and the retry attempt being 30 minutes. Based on this retry configuration, only one retry attempt is performed for a destination in a foreign network. Thus, the network operator will only be charged for two queries to the foreign HLR/HSS, which may advantageously lower the overall cost of the messaging service.

FIG. 5 is a flow chart illustrating a method 500 of identifying a retry configuration from retry configuration table 400 in an exemplary embodiment. In step 502, delivery system 122 processes the message to identify a destination ID included in the message. The destination ID may be inserted in a header of the message, such as in a destination field. In step 504, delivery system 122 searches retry configuration table 400 (see FIG. 4) based on the destination ID to identify the retry configuration mapped to the destination ID. The retry configuration identified in step 504 represents an individualized retry configuration for this particular message, which is based on the destination ID. Delivery system 122 then initiates subsequent retry attempts of the message based on the retry configuration found in retry configuration table 400.

A similar retry configuration table as shown in FIG. 4 may be generated that maps or associates sender information to retry configurations, such as a sender ID.

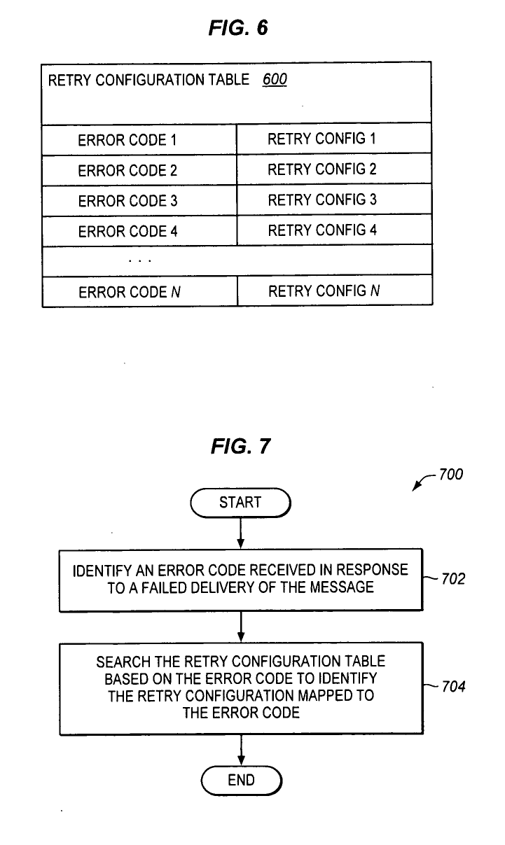

In another embodiment, delivery system 122 may process information on the traffic condition within mobile network 100 to identify the proper retry configuration. The traffic condition may be the overall condition within mobile network 100, or the traffic condition for destination 112. Retry database 124 may store a retry configuration table that maps or associates traffic condition information to retry configurations. As an example, FIG. 6 illustrates a retry configuration table 600 that maps network condition error codes to retry configurations in an exemplary embodiment. In this embodiment, retry configuration table 600 includes a plurality of error codes (or cause codes) labeled as error code 1, error code 2, error code 3, error code 4, . . . , error code N. An error code comprises data indicating the status or condition of the network, such as the available bandwidth. Each of the error codes is mapped to or associated with a retry configuration labeled as retry configuration 1, retry configuration 2, retry configuration 3, retry configuration 4, . . . , retry configuration N.

As an example, assume that error code 1 is a cause code indicating network congestion. The network operator may define a retry configuration for this cause code that is sensitive to network congestion. For example, retry configuration 1 may define a maximum of two retry attempts, where the interval between the initial delivery attempt and the first retry attempt is 1 hour, and the interval between the first retry attempt and the second retry attempt is 12 hours. Based on this retry configuration, the maximum number of retry attempts is low and the time interval between retry attempts is high, which may advantageously relieve traffic congestion within mobile network 100.

FIG. 7 is a flow chart illustrating a method 700 of identifying a retry configuration from retry configuration table 600 in an exemplary embodiment. In step 702, delivery system 122 identifies an error code (or cause code) that is received in response to a failed delivery of the message. The error code indicates a condition or congestion in mobile network 100. In step 704, delivery system 122 searches retry configuration table 600 (see FIG. 6) based on the error code to identify the retry configuration mapped to the error code. Delivery system 122 then initiates subsequent retry attempts of the message based on the retry configuration found in retry configuration table 600.

In yet another embodiment, delivery system 122 may process information on the time of day and/or day of the week to identify the proper retry configuration. Thus, retry database 124 may store a retry configuration table that maps or associates times and/or dates to retry configurations. As an example, FIG. 8 illustrates a retry configuration table 800 that maps times to retry configurations in an exemplary embodiment. In this embodiment, retry configuration table 800 includes a plurality of times labeled as TOD 1, TOD 2, TOD 3, TOD 4, . . . , TOD N. The TOD may be a time or a time range/period. Each of the TODs is mapped to or associated with a retry configuration labeled as retry configuration 1, retry configuration 2, retry configuration 3, retry configuration 4, . . . , retry configuration N.

As an example, assume that TOD 1 is a time period from 5:00 p.m. to 8:00 p.m. This time period represents a peak traffic period for messages. Thus, the network operator may define a retry configuration for this time period that is sensitive to peak traffic congestion. For example, retry configuration 1 may define a maximum of three retry attempts, where the interval between the initial delivery attempt and the first retry attempt is 10 minutes, the interval between the first retry attempt and the second retry attempt is 3 hours, and the interval between the second retry attempt and the third retry attempt is 12 hours. Based on the retry configuration, only one retry attempt is performed during the peak traffic period. The other retry attempts are guaranteed to be outside of the peak traffic period, which may advantageously relieve traffic congestion within mobile network 100.

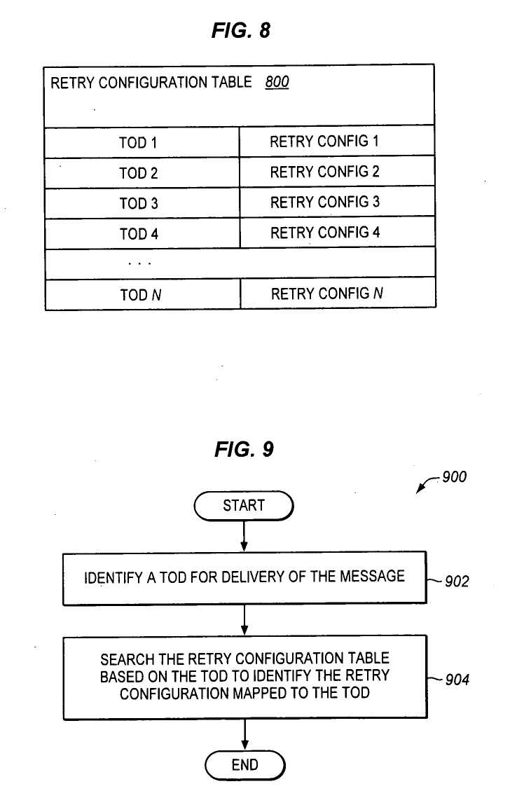

FIG. 9 is a flow chart illustrating a method 900 of identifying a retry configuration from retry configuration table 800 in an exemplary embodiment. In step 902, delivery system 122 identifies a time of day (TOD) for delivery of the message. The TOD may be the time the message was first sent. Thus, delivery system 122 may process a time stamp in the message to identify the TOD. The TOD may alternatively comprise the time for a subsequent retry attempt. Thus, delivery system 122 may process a local clock to identify the TOD for the retry attempt. In step 904, delivery system 122 searches retry configuration table 800 (see FIG. 8) based on the TOD to identify the retry configuration mapped to the TOD. Delivery system 122 then initiates subsequent retry attempts of the message based on the retry configuration found in retry configuration table 800.

Any of the above retry configuration tables may be merged so that the retry configuration for a message may depend a multiple criterion. For example, a retry configuration may depend on the destination (or destination type), traffic conditions, and the time of day. If multiple criteria are defined, then the retry configuration table may further include a priority rule defining which criterion controls in the event of a conflict.

### EXAMPLE

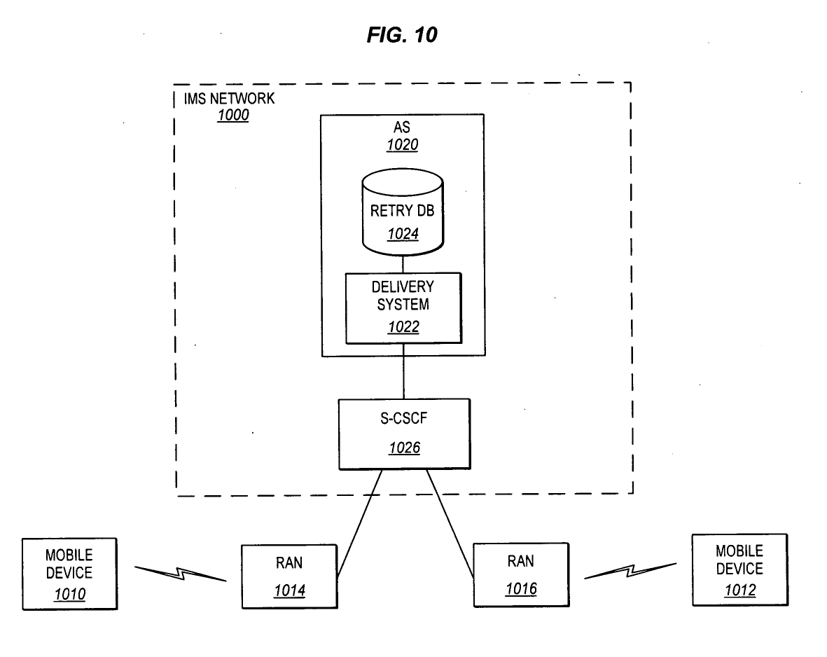

FIG. 10 illustrates an IMS network 1000 in an exemplary embodiment. In this embodiment, IMS network 1000 is operable to serve a mobile device 1010 through a Radio Access Network (RAN) 1014, which comprises any radio or wireless network that interfaces a mobile device with a core network. To serve mobile device 1010, IMS network 1000 includes an application server (AS) 1020 and a Serving-Call Session Control Function (S-CSCF) 1026. Application server 1020 is operable to handle SMS messages, and may represent an SMSC. As part of handling SMS messages, application server 1020 includes a delivery system 1022 that uses SMS protocol, and includes a retry database 1024 operable to store a plurality of retry configurations. Delivery system 1022 is able to deliver SMS messages to destinations using store-and-forward processing, such as delivering an SMS message to mobile device 1012 through RAN 1016.

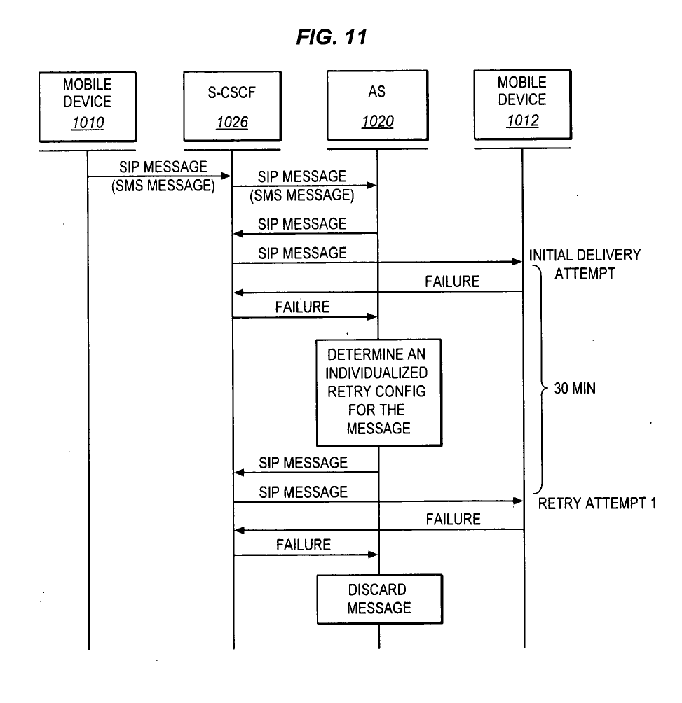

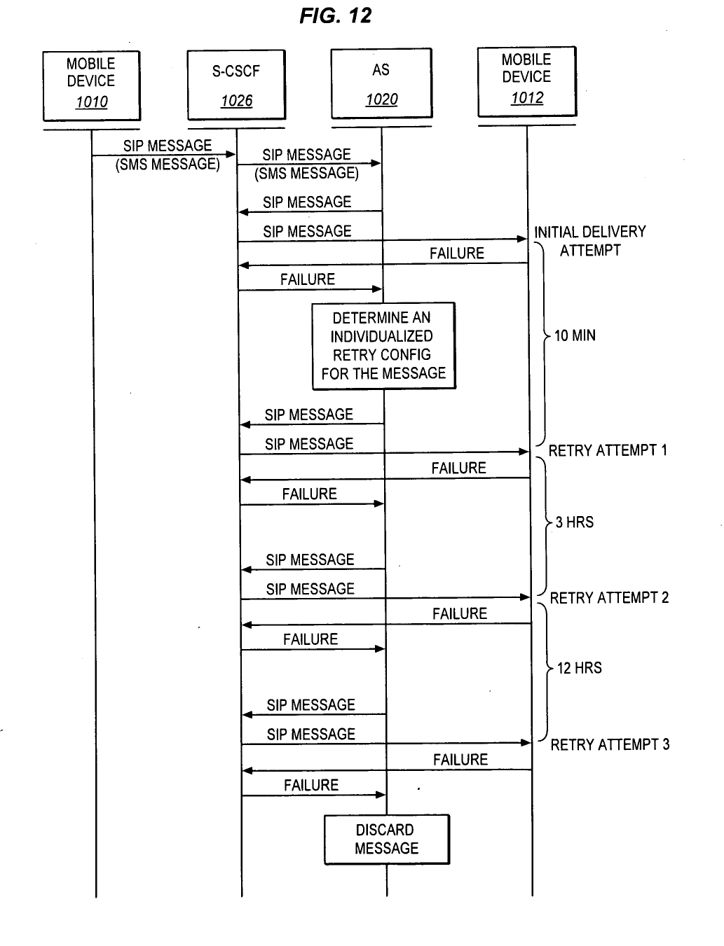

FIGS. 11-12 are message diagrams illustrating retry delivery using an individualized retry configuration in an exemplary embodiment. In FIG. 11, assume that a user of mobile device 1010 initiates an SMS message to a user of mobile device 1012. Mobile device 1010 encapsulates the SMS message in a SIP MESSAGE, and sends the SIP MESSAGE to S-CSCF 1026. S-CSCF 1026 identifies the SIP MESSAGE as including an SMS message, and forwards the SIP MESSAGE to application server (AS) 1020. In response to receiving the message, application server 1020 stores the message, and then attempts to deliver the message to mobile device 1012 by sending a SIP MESSAGE to S-CSCF 1026 which in turn forwards the SIP MESSAGE to mobile device 1012. If delivery is unsuccessful (shown as a failure indication received by application server 1020), then application server 1020 identifies an individualized retry configuration for this SMS message.

Assume for this embodiment that retry database 1024 (see FIG. 10) is programmed with a retry configuration table (illustrated in FIG. 4) that maps retry configurations to destination IDs. Further assume that mobile device 1012 is located in a foreign network. Application server 1020 processes the SIP MESSAGE to identify the destination ID for mobile device 1012. Application server 1020 then searches in the retry configuration table for an entry matching the destination ID in the SIP MESSAGE. If a match is found, then application server 1020 identifies the retry configuration mapped to the destination ID in the retry database 1024. Assume that the identified retry configuration defines a maximum of one retry attempt, where the interval between the initial delivery attempt and the retry attempt is 30 minutes. Based on the retry configuration, application server 1020 waits 30 minutes from the initial delivery attempt. After the 30 minutes expires, application server 1020 initiates the first (and only) retry attempt to mobile device 1012 by sending a SIP MESSAGE to S-CSCF 1026 which in turn forwards the SIP MESSAGE to mobile device 1012. If the first retry attempt is unsuccessful, then application server 1020 discards the SMS message based on the retry configuration.

In FIG. 12, assume again that the user of mobile device 1010 initiates an SMS message to the user of mobile device 1012. Mobile device 1010 sends the SMS message in a SIP MESSAGE to S-CSCF 1026, and S-CSCF 1026 forwards the SIP MESSAGE to application server (AS) 1020. In response to receiving the message, application server 1020 stores the message, and then attempts to deliver the message to mobile device 1012 by sending a SIP MESSAGE to S-CSCF 1026 which in turn forwards the SIP MESSAGE to mobile device 1012. If delivery is unsuccessful (shown as a failure indication received by SMS AS 1020), then application server 1020 identifies an individualized retry configuration for this SMS message.

Assume for this embodiment that retry database 1024 (see FIG. 10) is programmed with a retry configuration table (illustrated in FIG. 8) that maps retry configurations to a time of day (TOD). Application server 1020 processes the SIP MESSAGE to identify a time stamp indicating when the SMS message was first sent. Application server 1020 then searches in the retry configuration table for an entry matching the TOD in the SIP MESSAGE. If a match is found, then application server 1020 identifies the retry configuration mapped to the TOD. Assume that the retry configuration for this TOD defines a maximum of three retry attempts, where the interval between the initial delivery attempt and the first retry attempt is 10 minutes, the interval between the first retry attempt and the second retry attempt is 3 hours, and the interval between the second retry attempt and the third retry attempt is 12 hours. Based on the retry configuration, application server 1020 waits for 10 minutes from the initial delivery attempt. After 10 minutes expires, application server 920 initiates the first retry attempt to mobile device 1012 by sending a SIP MESSAGE to S-CSCF 1026 which in turn forwards the SIP MESSAGE to mobile device 1012. If the first retry attempt is unsuccessful, then application server 1020 waits for 3 hours from the first retry attempt. After 3 hours expires, application server 1020 initiates the second retry attempt to mobile device 1012 by sending a SIP MESSAGE to S-CSCF 1026 which in turn forwards the SIP MESSAGE to mobile device 1012. If the second retry attempt is again unsuccessful, then application server 1020 waits for 12 hours from the second retry attempt. After 12 hours expires, application server 1020 initiates the third (and final) retry attempt to mobile device 1012 by sending a SIP MESSAGE to S-CSCF 1026 which in turn forwards the SIP MESSAGE to mobile device 1012. If the third retry attempt is unsuccessful, then application server 1020 discards the SMS message based on the retry configuration.

FIGS. 11-12 show that retry configurations in IMS network 1000 are determined on a per-message basis. Depending on the destination of the message, the time of day, or other information related to the delivery of the message, an individualized retry configuration is determined dynamically, which advantageously gives the network operator more control over how the retry process is performed for each message.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A message center for a mobile network, the message center comprising:
a retry database operable to store a plurality of retry configurations each defining rules for retry attempts of a message; and
a delivery system operable to receive a message, to initiate a delivery attempt of the message to the destination, and to identify a failure of the delivery attempt;
the delivery system further operable to identify an individualized retry configuration for the message from the plurality of retry configurations stored in the retry database, and to initiate at least one retry attempt for the message based on the individualized retry configuration.

2. The message center of claim 1 wherein:
the retry database is further operable to store a table that maps the plurality of retry configurations to destinations; and
the delivery system is further operable to identify the individualized retry configuration based on the destination of the message.

3. The message center of claim 1 wherein:
the retry database is further operable to store a table that maps the plurality of retry configurations to senders; and
the delivery system is further operable to identify the individualized retry configuration for the message based on a sender of the message.

4. The message center of claim 1 wherein:
the retry database is further operable to store a table that maps the plurality of retry configurations to traffic conditions; and
the delivery system is further operable to identify the individualized retry configuration for the message based on a traffic condition in the mobile network.

5. The message center of claim 1 wherein:
the retry database is further operable to store a table that maps the plurality of retry configurations to times of day; and
the delivery system is further operable to identify the individualized retry configuration for the message based on a time of day.

6. The message center of claim 1 wherein the individualized retry configuration defines a number of subsequent retry attempts for the message.

7. The message center of claim 1 wherein the individualized retry configuration defines at least one time interval between retry attempts for the message.

8. A method within a mobile network, the method comprising:
storing a plurality of retry configurations each defining rules for retry attempts of a message;
receiving a message;
initiating a delivery attempt of the message to the destination; and
identifying a failure of the delivery attempt;
in response to the failure, the method further includes:
identifying an individualized retry configuration for the message from the plurality of stored retry configurations; and
initiating at least one retry attempt for the message based on the individualized retry configuration.

9. The method of claim 8 wherein:
storing a plurality of retry configurations comprises storing a table that maps the plurality of retry configurations to destinations; and
identifying the individualized retry configuration for the message comprises identifying the individualized retry configuration based on the destination of the message.

10. The method of claim 8 wherein:
storing a plurality of retry configurations comprises storing a table that maps the plurality of retry configurations to senders; and
identifying the individualized retry configuration for the message comprises identifying the individualized retry configuration for the message based on a sender of the message.

11. The method of claim 8 wherein:
storing a plurality of retry configurations comprises storing a table that maps the plurality of retry configurations to traffic conditions; and
identifying the individualized retry configuration for the message comprises identifying the individualized retry configuration for the message based on a traffic condition in the mobile network.

12. The method of claim 8 wherein:
storing a plurality of retry configurations comprises storing a table that maps the plurality of retry configurations to times of day; and
identifying the individualized retry configuration for the message comprises identifying the individualized retry configuration for the message based on a time of day.

13. The method of claim 8 wherein the individualized retry configuration defines a number of subsequent retry attempts for the message.

14. The method of claim 8 wherein the individualized retry configuration defines at least one time interval between retry attempts for the message.

15. A computer readable medium tangibly embodying programmed instructions which, when executed by a computer system, are operable to execute a method within a mobile network, the method comprising:
storing a plurality of retry configurations each defining rules for retry attempts of a message;
receiving a message;
initiating a delivery attempt of the message to the destination; and
identifying a failure of the delivery attempt;
in response to the failure, the method further includes:
identifying an individualized retry configuration for the message from the plurality of stored retry configurations; and
initiating at least one retry attempt for the message based on the individualized retry configuration.

16. The computer readable medium of claim 15 wherein:
storing a plurality of retry configurations comprises storing a table that maps the plurality of retry configurations to destinations; and
identifying the individualized retry configuration for the message comprises identifying the individualized retry configuration based on the destination of the message.

17. The computer readable medium of claim 15 wherein:
storing a plurality of retry configurations comprises storing a table that maps the plurality of retry configurations to traffic conditions; and
identifying the individualized retry configuration for the message comprises identifying the individualized retry configuration for the message based on a traffic condition in the mobile network.

18. The computer readable medium of claim 15 wherein:
storing a plurality of retry configurations comprises storing a table that maps the plurality of retry configurations to times of day; and
identifying the individualized retry configuration for the message comprises identifying the individualized retry configuration for the message based on a time of day.

19. The computer readable medium of claim 15 wherein the individualized retry configuration defines a number of subsequent retry attempts for the message.

20. The computer readable medium of claim 15 wherein the individualized retry configuration defines at least one time interval between retry attempts for the message.
